(19) United States
(12) Patent Application Publication
(10) Pub. No.: US 2008/0098104 A1
(43) Pub. Date: Apr. 24, 2008

(54) IMAGE FORMING APPARATUS, IMAGE FORMING SYSTEM AND CONTROL METHOD THEREOF

(75) Inventor: Tae-kook KONG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd Suwon-si, Republic of Korea

(21) Appl. No.: 11/870,581

(22) Filed: Oct. 11, 2007

(30) Foreign Application Priority Data
Oct. 18, 2006 (KR) 2006101496

(51) Int. Cl. G06F 15/173

(52) U.S. Cl. 709/223

(57) ABSTRACT

An image forming apparatus includes a storage unit, an interface unit to communicate with a network server through a network, and a controller to store a registration reservation information in the storage unit to register with the network server, and controls the interface unit to transmit the registration reservation information.

### CROSS-REFERENCE TO RELATED APPLICATIONS

This application claims priority under 35 U.S.C. §119(a) from Korean Patent Application No. 2006-0101496, filed on Oct. 18, 2006 in the Korean Intellectual Property Office, the disclosure of which is incorporated herein in its entirety by reference.

### BACKGROUND OF THE INVENTION

1. Field of the Invention

The present general inventive concept relates to an image forming apparatus, an image forming system, and a control method thereof, and more particularly, to an image forming apparatus and an image forming system having an efficient registration management of a network server.

2. Description of the Related Art

An image forming system includes a plurality of image forming apparatuses and a network server.

The plurality of image forming apparatuses, such as a scanner, a facsimile, a printer, and a multi-function printer, are registered in the network server through a network and managed by the network server.

That is, as networking progresses in an office, an image forming system enabling multi-output capability is implemented by connecting a scanner generating image data, a printer outputting a paper recorded with an image based on image data, and a network server managing the above devices, to a network.

In order to register a plurality of image forming apparatuses in such an image forming system, a user must memorize a model name and an Internet Protocol (IP) address of each image forming apparatus for registration in the network server. That is, a display unit of the network server displays model names and IP addresses of overall image forming apparatuses connected to the network that are compatible with the network server.

However, the display unit of the network server may not display information on an image forming apparatus to be registered in the network server among the plurality of image forming apparatuses, and therefore, the user must memorize all model names and IP addresses of the image forming apparatuses so as to register the image forming apparatuses in the network server.

The above information disclosed in this Background section is only for enhancement of understanding of the background of the general inventive concept and therefore it may contain information that does not form the prior art that is already known in this country to a person of ordinary skill in the art.

### SUMMARY OF THE INVENTION

The present general inventive concept provides an image forming apparatus, an image forming system, and a control method thereof with efficient registration management of a network server.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image forming apparatus comprising a storage unit, an interface unit to communicate with a network server through a network, and a controller which stores a registration reservation information in the storage unit to register with the network server, and controls the interface unit to transmit the registration reservation information.

The image forming apparatus may further comprise a display unit, wherein the controller controls the display unit to display a confirmation information on whether registration reservation has been requested.

The image forming apparatus may further comprise a user input unit, wherein the controller controls the display unit to displays a registration reservation screen when a registration reservation command is input through the user input unit.

The registration reservation screen may comprise an icon which indicates registration reservation.

The registration reservation screen may further comprise an input area through which a text can be input, wherein the text is to be displayed to register in the network server.

The controller can store the text input through the input area of the registration reservation screen as the registration reservation information in the storage unit.

The foregoing and/or other aspects and utilities of the present general inventive concept can also be achieved by an image forming system comprising an image forming apparatus comprising a storage unit, a first interface unit to communicate with a network server through a network, and a first controller to store a registration reservation information for registration in the network server in the storage unit, and the network server comprising a second interface unit to communicate with the image forming apparatus through the network, and a second controller which controls the second interface to request the registration reservation information from the image forming apparatus.

The first controller can control the first interface unit to transmit the registration reservation information to the network server when the network server has requested the registration reservation information.

The network server may further comprise a display unit, and the second controller can control the display unit to displays a registration setting screen which includes the registration reservation information.

The network server may further comprise a user input unit, and the second controller may perform registration so that the image forming apparatus can be used according to a registration command input through the user input unit.

The second controller can control the second interface unit to transmit at least one of a registration reservation release information and a registration information when the registration of the image forming apparatus is completed.

The foregoing and/or other aspects and utilities of the present invention can also be achieved by providing a method of controlling an image forming apparatus having an interface unit and a storage unit, the method comprising setting a registration reservation information to register the image forming apparatus in a network server when the interface unit is connected with the network, and transmitting the registration reservation information when the registration reservation information is requested from the network server.

The setting of the registration reservation information may comprise displaying a confirmation information on whether registration reservation has been requested when a registration information is not stored in the storage unit.

The setting of the registration reservation information may further comprise displaying a registration reservation screen when a registration reservation command is input by a user.

The registration reservation screen may comprise an icon which indicates registration reservation.

The registration reservation screen may further comprise an input area through which a text can be input, and the text is to be displayed in the network server for registration.

The setting of the registration reservation information may further comprise storing the text input through the input area of the registration reservation screen as the registration reservation information in the storage unit.

The foregoing and/or other aspects and utilities of the present general inventive concept can also be achieved by providing a method of controlling an image forming system having a network server and an image forming apparatus, the method comprising setting a registration reservation information to register the image forming apparatus in the network server so that the image forming apparatus can be used when the image forming apparatus is connected to a network, requesting the registration reservation information from the image forming apparatus by the network server, and transmitting the registration reservation information to the network server from the image forming apparatus.

The method may further comprise displaying a registration setting screen on the network server, wherein the registration setting screen includes the registration reservation information received from the image forming apparatus.

The may further comprise registering the image forming apparatus in the network server so that the image forming apparatus can be used when a registration command is input by a user.

The method may further comprise transmitting at least one of a registration reservation release information and a registration information to the image forming apparatus when the registration of the image forming apparatus with the network server is completed.

The foregoing and/or other aspects and utilities of the present general inventive concept can also be achieved by providing an image forming apparatus, comprising an interface unit to communicate with a network, and a controller to determine whether the image forming apparatus is registered with the network and to control the interface to transmit a registration information to the network, wherein the controller requests a user to input registration reservation information to register with the network server when the controller determines that the image forming apparatus is not registered with the network.

The image forming apparatus may further comprise a storage unit to store the registration reservation information to register with the network server.

The network server may comprise a network interface unit to communicate with the image forming apparatus, and a network controller to control the network interface to request the registration reservation information from the image forming apparatus.

The foregoing and/or other aspects and utilities of the present general inventive concept can also be achieved by providing a method of registering an image forming apparatus to a network, the method comprising connecting an image forming device to the network, requesting registration information from the image forming device to register with the network, determining whether the registration information is stored in the image forming apparatus, transmitting the registration information to the network to register the image forming apparatus when it is determined that the registration information is stored in the image forming apparatus, and requesting a user to supply registration information to the image forming apparatus when the registration information is not stored in the image forming apparatus and storing the supplied registration information in the image forming apparatus.

The foregoing and/or other aspects and utilities of the present general inventive concept can also be achieved by providing a computer readable recording medium comprising computer readable codes to control an image forming apparatus having an interface unit and a storage unit, comprising setting a registration reservation information to register the image forming apparatus in a network server when the interface unit is connected with the network, and transmitting the registration reservation information when the registration reservation information is requested from the network server.

The foregoing and/or other aspects and utilities of the present general inventive concept can also be achieved by providing a computer readable recording medium comprising computer readable codes to register an image forming apparatus to a network, comprising connecting an image forming device to the network, requesting registration information from the image forming device to register with the network, determining whether the registration information is stored in the image forming apparatus, transmitting the registration information to the network to register the image forming apparatus when it is determined that the registration information is stored in the image forming apparatus, and requesting a user to supply registration information to the image forming apparatus when the registration information is not stored in the image forming apparatus and storing the supplied registration information in the image forming apparatus.

### BRIEF DESCRIPTION OF THE DRAWINGS

These and/or other aspects and utilities of the present general inventive concept will become apparent and more readily appreciated from the following description of the exemplary embodiments, taken in conjunction with the accompanying drawings of which:

FIG. 1 is a schematic diagram illustrating a network configuration of an image forming system according to an exemplary embodiment of the present general inventive concept.

FIG. 2 is a block diagram illustrating a network server according to the exemplary embodiment of the present general inventive concept.

FIG. 3 is a schematic block diagram illustrating an image forming apparatus according to the exemplary embodiment of the present general inventive concept.

FIG. 4 illustrates a flowchart of an image forming apparatus control process according to an exemplary embodiment of the present general inventive concept.

FIG. 5 illustrates a flowchart of a process of controlling the image forming system through interlocking according to the exemplary embodiment of the present general inventive concept.

FIG. 6A illustrates a screen to request a registration reservation according to the exemplary embodiment of the present general inventive concept.

FIG. 6B illustrates a registration reservation screen according to the exemplary embodiment of the present general inventive concept.

FIG. 7 illustrates a registration setting screen according to the exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

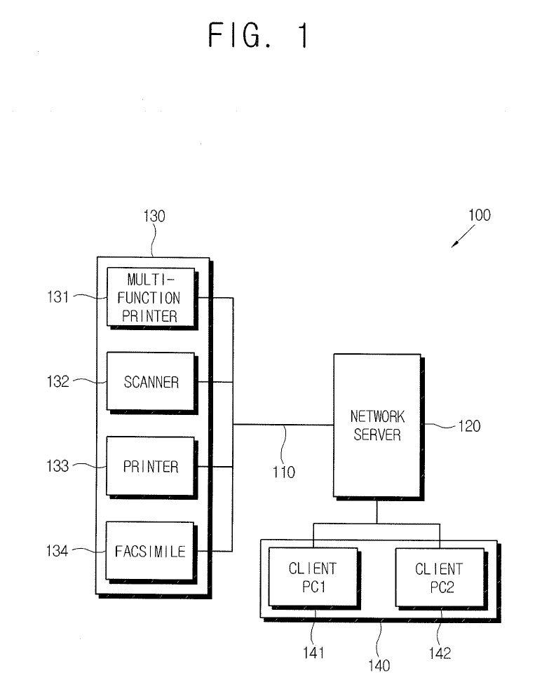

FIG. 1 is a schematic diagram illustrating a network configuration of an image forming system according to an exemplary embodiment of the present general inventive concept,

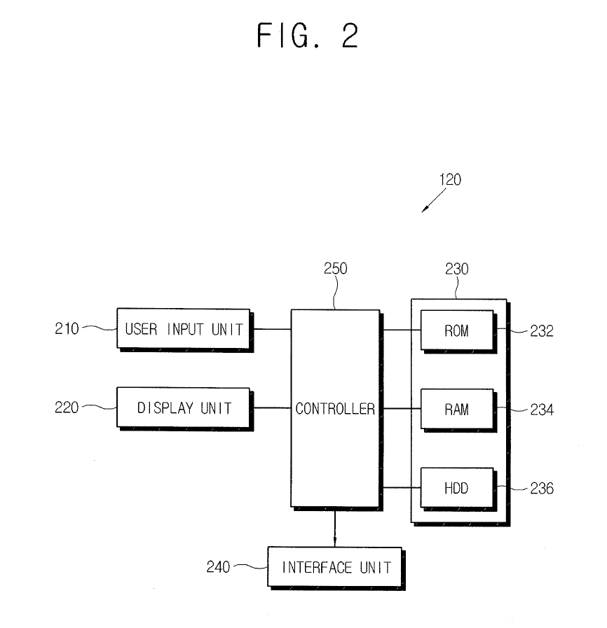

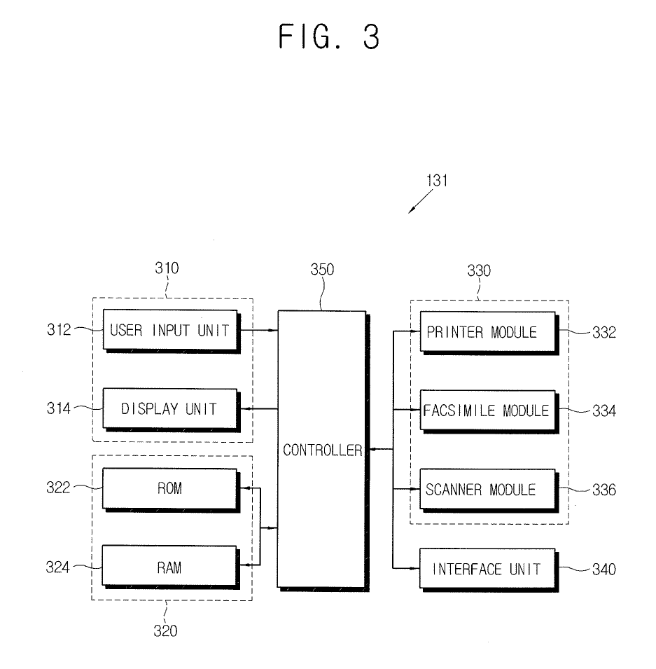

FIG. 2 is a block diagram illustrating a network server according to the exemplary embodiment of the present general inventive concept, and FIG. 3 is a schematic block diagram illustrating an image forming apparatus according to the exemplary embodiment of the present general inventive concept.

An image forming system 100 may include a network server 120, a plurality of image forming apparatuses 130, and a plurality of client personal computers (PCs) 140 which are connected by a network 110 through an Internet or a local area network (LAN).

As illustrated in FIG. 2, the network server 120 may include a user input unit 210, a display unit 220, a storage unit 230, an interface unit 240, and a controller 250.

The user input unit 210 can receive a command to set or select a function supported by the network server 120 from a user, and can transmit a key input signal therethrough to the controller 250.

Particularly, the user input unit 210 may include a key through which a registration command can be input.

The user input unit 210 also may include a keyboard in addition to keys provided on a control panel of the network server 120.

The display unit 220 can display a function supported by the network server 120 to a user, and thus it may display a model name or an IP address of each of the plurality of image forming apparatuses 130 connected to the network server 120 through the network 110 according to control of the controller 250. The display unit 220 may include a liquid crystal display (LCD) of a control panel unit provided in the network server 120 and a general monitor as well. The storage unit 230 may include a read-only memory (ROM) 232, a random-access memory (RAM) 234, and a hard disk drive (HDD) 236.

The ROM 232 is a non-volatile memory element, which preserves its data when power is turned off, and may include a flash memory. The ROM 232 can store various control programs required to perform various functions supported by the network server 120.

The RAM 234 is a volatile memory, which loses all data stored in the RAM 234 when the power is turned off, but stores various data generated during operation of the network server 120. In addition, the RAM 234 can temporally store image data transmitted/received through the interface unit 240.

The HDD 236 is a storage medium used to store a large amount of data in the network server 120. The HDD 236 can be operated by a file system so as to name a file and logically locate the file for a storing or searching operation. A file can be located in a folder or a sub-directory in a hierarchical structure.

The interface unit 240 can be provided to enable communication between the network server 120 and the image forming apparatus 130 or the client PC 140 through the network 110, and can transmit/receive image data and control data therethrough.

The image forming apparatus 130 registered in the network server 120 forms an image and may include a plurality of image forming devices, such as a multi-function printer 131, a scanner 132, a printer 133, and a facsimile 134. The plurality of image forming apparatuses 130 are connected to the network server 120 through the network 110.

FIG. 3 is a schematic block diagram illustrating one multi-function printer 131 as one of the image forming apparatuses 130.

The multi-function printer 131 may include a control panel unit 310, a storage unit 320, a plurality of modules 330, an interface unit 340, and a controller 350.

The control panel unit 310 may include a user input unit 312 and a display unit 314 through which the user can enter a proper command to the multi-function printer 131.

The user input unit 312 may include a plurality of function keys to set and select a function supported by the multi-function printer 131, and a key input signal generated from the function key operation can be input to the controller 350.

The display unit 314 can be provided as a liquid crystal display LCD, and can display an operation state and a function of the multi-function printer 131 according to control of the controller 350.

The storage unit 320 may include a ROM 322 and a RAM 324. The ROM 322 stores various control programs required to perform various functions supported by the multi-function printer 131. The RAM 324 can store data to be performed by plurality of modules 330. The storage unit 320 may include a flash memory (not illustrated) to store registration reservation information when the power is turned off.

The plurality of modules 330 may include a printer module 332, a facsimile module 334, and a scanner module 336, to respectively perform an independent function.

The interface unit 340 is provided to communicate with the network server 120 through the network 110, and can transmit/receive image data and control data according to control of the controller 350.

The controller 350 controls overall operation of the multi-function printer 131 according to a control program that can be stored in the ROM 322. When a registration reservation command is input through the user input unit 312, the controller 350 displays a registration reservation screen on the display unit 314 and stores a registration reservation information input through the user input unit 312 in the storage unit 320.

The plurality of client PCs 140 respectively access the network server 120 through the network 110.

A method of controlling the image forming apparatus and the image forming system will be described in further detail.

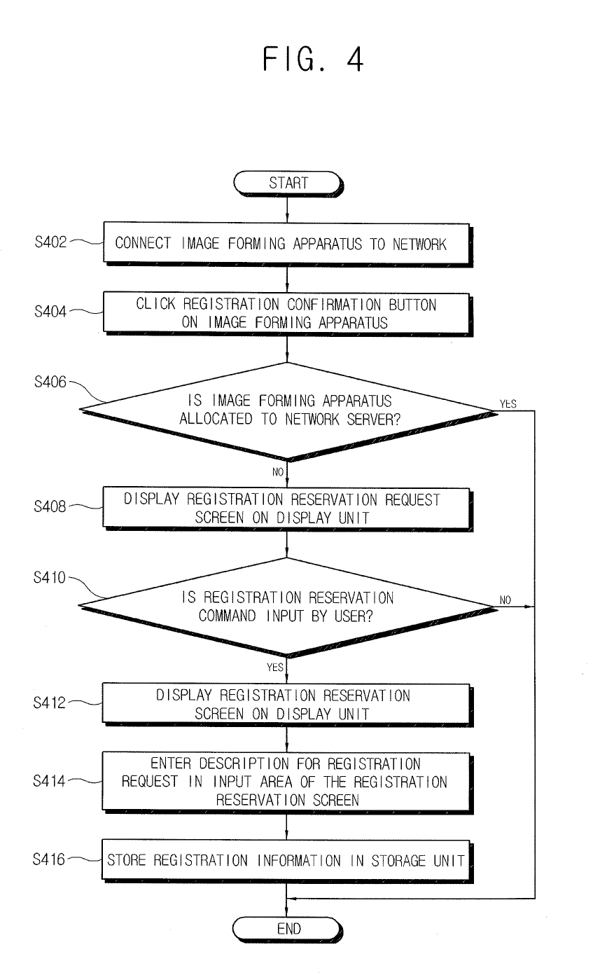

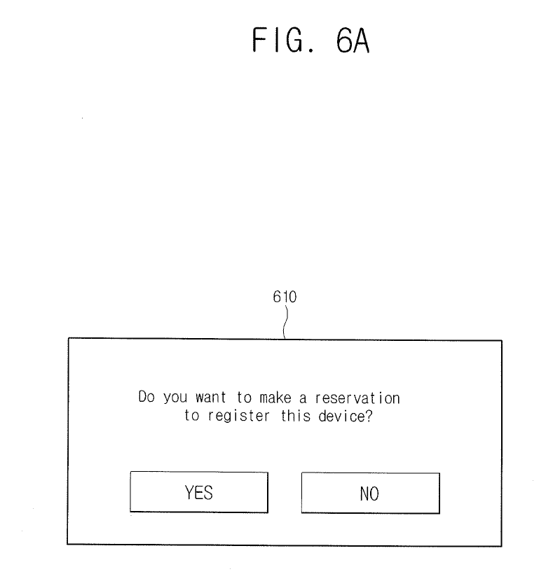

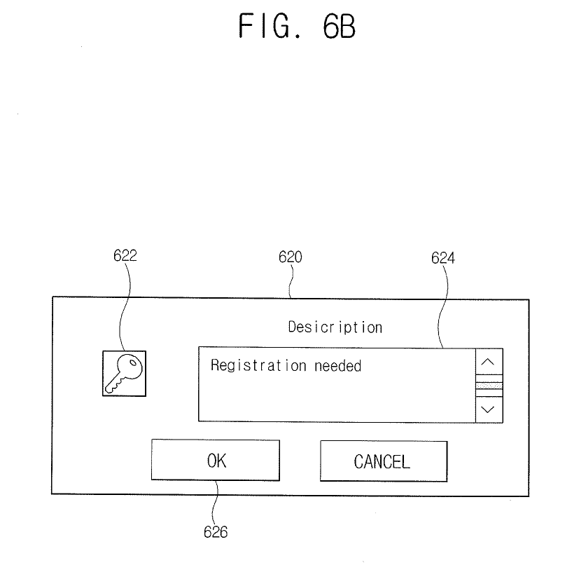

FIG. 4 illustrates a flowchart of an image forming apparatus control process according to the exemplary embodiment of the present general inventive concept, FIG. 6A illustrates a screen to request a registration reservation according to the exemplary embodiment of the present general inventive concept, and FIG. 6B illustrates a registration reservation screen according to the exemplary embodiment of the present general inventive concept.

A process to store a registration reservation information in the storage unit 320 of the image forming apparatus 130 of FIGS. 1-3 will be described with reference to FIG. 4.

The user connects the interface unit 340 of the image forming apparatus 130 to the network 110 in order to connect the image forming apparatus 130 to the network at operation S402. Then, the user clicks a registration confirmation button provided in the image forming apparatus 130 so as to confirm whether the corresponding image forming apparatus 130 is allocated to the network server 120, at operation S404.

When the registration confirmation button is clicked, the image forming apparatus 130 checks a registration flag stored in the storage unit 230 so as to check whether the image forming apparatus 130 is allocated to the network server 120 at operation S406, and terminates a registration reservation process of the image forming apparatus 130 when the image forming apparatus 130 is registered in the network server 120.

However, when the image forming apparatus 130 is not registered with the network server 120, the controller 350 displays a registration reservation request screen 610 on the display unit 314 to check whether the user needs a registration reservation, at operation S408.

FIG. 6A illustrates the registration reservation request screen 610 according to an embodiment of the present general inventive concept.

When a registration reservation command is input by the user through the user input unit 312 at operation S410, a registration reservation screen 620 as illustrated in FIG. 6B is displayed on the display unit 314 at operation S412.

The registration reservation screen 620 may include an icon 622 to register reservation and an input area 624 through which a text to be displayed for the registration can be input. The user enters the text related to registration request to the network server 120 through the input area 624 of the registration reservation screen 620 at operation S414. When the user clicks an OK button 626, the icon 622 and the text entered to the input area 624 are stored as a registration reservation information in the storage unit 320 at operation S416.

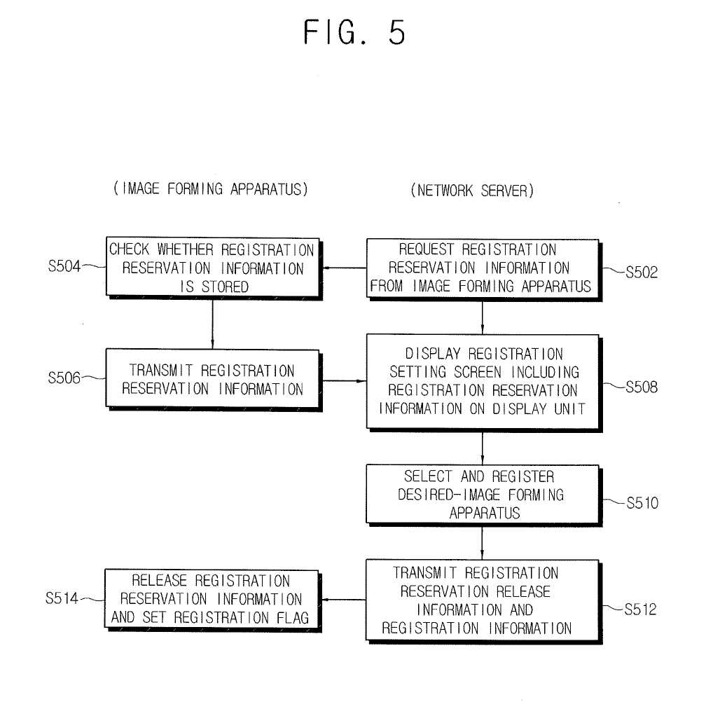

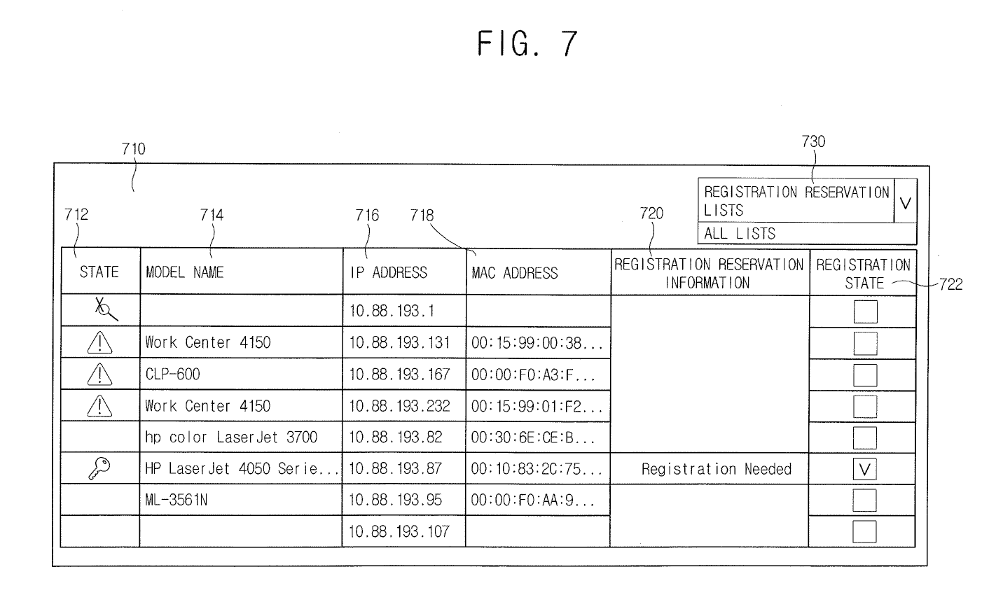

FIG. 5 illustrates a flowchart of a control process of the image forming system by interlocking according to an embodiment of the present general inventive concept, and FIG. 7 illustrates an exemplary screen to display a registration setting screen according to the exemplary embodiment of the present general inventive concept.

The controller 250 of the network server 120 controls the interface unit 240 to request a registration reservation information from the image forming apparatus 130 at operation S502.

The controller 350 of the image forming apparatus 130 analyzes the information received from the interface unit 340, and checks whether the registration reservation information is stored in the storage unit 320 when it is determined that the network server 120 has requested the registration reservation information, at operation S504. When the registration reservation information is stored in the storage unit 320, the controller 350 transmits the registration reservation information to the network server 120 through the interface unit 340, at operation S506.

The controller 250 of the network server 120 displays the registration setting screen including the registration reservation information received from the image forming apparatus 130 on the display unit 220, at operation S508.

FIG. 7 illustrates a registration setting screen 710 displayed on the display unit 220, and the registration setting screen 710 displays only image forming apparatus 130 that are not registered with the network server 120.

The registration setting screen 710 can display a display state 712, a model name 714, an IP address 716, a medium access control (MAC) address 718, a registration reservation information 720, and a registration state 722. In this case, a filter 730 may be used to selectively display “all lists” or “registration reservation lists” of an unregistered image forming apparatus 130.

When a user selects a check box of the registration state 722 in the registration setting screen 710 to register the image forming apparatus 130 and enters a registration command through the user input unit 210, the image forming apparatus 130 is registered in the network server 120, at operation S510.

When the registration of the image forming apparatus 130 in the network server 120 is completed, a registration reservation release information and a registration information are transmitted to the image forming apparatus 130, at operation S512.

The controller 350 of the image forming apparatus 130 releases the registration reservation information stored in the storage unit 320 by using the registration reservation release information and the registration information received from the network server 120, and sets a registration flag, at operation S514.

FIG. 5 illustrates a process to request a registration reservation information from the network server 120.

According to another exemplary embodiment of the present general inventive concept, it is possible to program that the registration reservation information is automatically transmitted to the network server 120 and the network server 120 stores and manages the registration reservation information after the registration reservation information is stored in the image forming apparatus 130.

In this case, the network server 120 does not need to transmit the registration reservation release information and the registration information to the image forming apparatus 130.

Various embodiments of the present general inventive concept can be embodied as computer readable codes on a computer-readable medium. The computer-readable medium includes a computer-readable recording medium and a computer-readable transmission medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable transmission medium can be distributed over network coupled computer systems, through wireless or wired communications over the internet, so that the computer readable code is stored and executed in a distributed fashion. Various embodiments of the present general inventive concept may also be embodied in hardware or in a combination of hardware and software.

As described above, the present general inventive concept provides an efficient management of image forming apparatuses that need registrations among a plurality of image forming apparatuses connected in a network.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a storage unit;
an interface unit to communicate with a network server through a network; and
a controller which stores a registration reservation information in the storage unit to register with the network server, and controls the interface unit to transmit the registration reservation information.

2. The image forming apparatus of claim 1, further comprising:
a display unit,
wherein the controller controls the display unit to display a confirmation information on whether registration reservation has been requested.

3. The image forming apparatus of claim 2, further comprising:
a user input unit,
wherein the controller controls the display unit to displays a registration reservation screen when a registration reservation command is input through the user input unit.

4. The image forming apparatus of claim 3, wherein the controller stores a text input through an input area of the registration reservation screen as the registration reservation information in the storage unit.

5. A method of controlling an image forming apparatus having an interface unit and a storage unit, the method comprising:
setting a registration reservation information to register the image forming apparatus in a network server when the interface unit is connected with the network; and
transmitting the registration reservation information when the registration reservation information is requested from the network server.

6. The method of claim 5, wherein the setting of the registration reservation information comprises:
displaying a confirmation information on whether registration reservation has been requested when a registration information is not stored in the storage unit.

7. The method of claim 6, wherein the setting of the registration reservation information further comprises:
displaying a registration reservation screen when a registration reservation command is input by a user.

8. The method of claim 7, wherein the setting of the registration reservation information further comprising:
storing a text input through an input area of the registration reservation screen as the registration reservation information in the storage unit.

9. A method of controlling an image forming system having a network server and an image forming apparatus, the method comprising:
setting a registration reservation information to register the image forming apparatus in the network server so that the image forming apparatus can be used when the image forming apparatus is connected to a network;
requesting the registration reservation information from the image forming apparatus by the network server; and
transmitting the registration reservation information to the network server from the image forming apparatus.

10. The method of claim 9, further comprising:
displaying a registration setting screen on the network server,
wherein the registration setting screen includes the registration reservation information received from the image forming apparatus.

11. The method of claim 10, further comprising:
registering the image forming apparatus in the network server so that the image forming apparatus can be used when a registration command is input by a user.

12. The method of claim 11, further comprising:
transmitting at least one of a registration reservation release information and a registration information to the image forming apparatus when the registration of the image forming apparatus with the network server is completed.

13. An image forming apparatus, comprising:
an interface unit to communicate with a network; and
a controller to determine whether the image forming apparatus is registered with the network and to control the interface to transmit a registration information to the network,
wherein the controller requests a user to input registration reservation information to register with the network server when the controller determines that the image forming apparatus is not registered with the network.

14. The image forming apparatus of claim 13, further comprising:
a storage unit to store the registration reservation information to register with the network server.

15. The image forming apparatus of claim 13, wherein the network server comprises:
a network interface unit to communicate with the image forming apparatus, and a network controller to control the network interface to request the registration reservation information from the image forming apparatus.

16. A method of registering an image forming apparatus to a network, the method comprising:
connecting an image forming device to the network;
requesting registration information from the image forming device to register with the network;
determining whether the registration information is stored in the image forming apparatus;
transmitting the registration information to the network to register the image forming apparatus when it is determined that the registration information is stored in the image forming apparatus; and
requesting a user to supply registration information to the image forming apparatus when the registration information is not stored in the image forming apparatus and storing the supplied registration information in the image forming apparatus.
